(19) United States
(12) Patent Application Publication
(10) Pub. No.: US 2005/0024338 A1
(43) Pub. Date: Feb. 3, 2005

(54) Finger-identifying keyboard

(75) Inventor: Sheng Ye, Beijing (CN)

Correspondence Address: DRIGGS, LUCAS BRUBAKER & HOGG CO. L.P.A., DEPT. IRA, 8522 EAST AVENUE, MENTOR, OH, 44060, US

(73) Assignee: International Business Machines Corporation, Armonk, NY (US)

(21) Appl. No.: 10/931,384

(22) Filed: Sep. 1, 2004

Related U.S. Application Data
(63) Continuation-in-part of application No. 10/097,803, filed on Mar. 14, 2002.

(30) Foreign Application Priority Data
Mar. 29, 2001 (CN) 01112131.9

(51) Int. Cl. G09G 5/00

(52) U.S. Cl. 345/168

(57) ABSTRACT

The present invention provides a finger-identifying keyboard, comprising a plurality of keys; a plurality of sensors, each of which uniquely represents and identifies a different finger; a coding synthesizer used to identify simultaneously the keys and the fingers used to press the keys, to synthesize the coding and to generate the resultant input coding signal. The invention can effectively reduce the number of keys on the keyboard, thereby achieving the goal of reducing the size of the keyboard so as to be adapted to the requirements of various handheld devices. Even though the size of the keyboard is reduced, the size of the finger keys can remain the same size to facilitate typing.

### CROSS REFERENCE TO RELATED APPLICATIONS

This application is a continuation-in-part of application Ser. No. 10/097,803, filed Mar. 14, 2002, for FINGER-IDENTIFYING KEYBOARD, which claims priority of Chinese application Serial No. 01112131.9, filed Mar. 14, 2002.

### BACKGROUND OF THE INVENTION

1. Field of the Invention

The present invention relates to a finger-identifying keyboard, and more particularly relates to a finger-identifying keyboard that can reduce the number of keys on the keyboard and the size of the keyboard.

2. Prior Art

Data inputting is an indispensable function of various electronic equipments. Among the vast amount of inputting methods, keyboard-inputting method is still the leading one with regard to speed and accuracy. In the process of miniaturization of electronic equipment, the size of the inputting device is continuously decreasing.

In prior art, there are some limitations on the miniaturization of the keyboards. First, in order for the users to input conveniently with their own fingers, the size of the keys can not be too small. Too small a key will either make the users unable to use fingers to press the key or readily produce errors. Second, in order to input enough number of digits and alphabetic characters, it is necessary to have a sufficient number of keys. Both of these two aspects limit the miniaturization progress of the keyboards.

U.S. Pat. No. 5,367,298 disclosed a keyboard, which, with reference to FIG. 1, reduces the number of keys to about one half of the number of keys of the standard keyboard, wherein each key is assigned to at least two characters. For example, “H”, “J”, “K”, “L” and ““'keys are assigned to “G”, “F”, “D”, “S” and “A” characters respectively according to their mirror positions. The characters are switched between each other by using the MODE key.

In the above configuration, the number of keys can be reduced. But the keyboard still has to have at least more than 20 keys for all the characters to be inputted. Hence, there is a limitation to further miniaturization of the keyboards.

### SUMMARY OF THE INVENTION

The present inventor has found through investigation that when people are using a keyboard, usually they are using different fingers to press different keys. If the fingers can be distinguished from each other, then the keystroke of the same key by different fingers can produce different combinations of characters, and produce different character output, thereby achieving the functions of a whole keyboard by using a small number of keys. For purposes of the present invention “character” shall mean and include numeric digits, letters of the alphabet, and various symbols carried on the keyboard for punctuation, as well as those symbols that are frequently encountered during typing such as $, &, %, +, = and so forth.

Therefore, the object of the invention is to provide a finger-identifying keyboard that can effectively reduce the number of keys, thereby reducing the size of the keyboard.

According to the invention, a finger-identifying keyboard is provided, which includes:
a plurality of keys;
a plurality of sensors wearable on the fingers, each of which represents a different finger;
a coding synthesizer used to identify simultaneously the keys and the fingers used to press the keys, thereby synthesizing the coding to generate a final input coding signal.

The above-mentioned sensors can be a kind of contact sensors.

The above sensors can also be a kind of magnetic sensors.

The number of the above-mentioned keys is preferably 15.

The number of said sensors worn on the fingers is preferably 4.

The above design of the invention can effectively reduce the number of the keys of the keyboard, thereby achieving the goal of reducing the size of the keyboard without sacrificing the availability of the full range of characters to be displayed. Since the method identifies the finger which presses the key, it has little influence on the inputting habit. For the handheld devices, the keyboard should be small enough to be easily carried around and in many cases only one hand is available for input. The finger-identifying keyboard can solve such a problem.

Further, the finger-identifying keyboard of the invention reduces the size of a keyboard without reducing the size of a key. It is especially suitable for data input in miniaturized and handheld devices. As it keeps the conventional inputting habit, it can be easily mastered. Due to the reduced number of keys, the number of electrical and mechanical components can be accordingly reduced while only a small number of electronic parts are added, therefore the cost will not exceed that of the conventional keyboard.

### BRIEF DESCRIPTION OF THE DRAWINGS

FIG. 1 is a schematic view of a prior art keyboard with reduced size.

FIG. 2 is an embodiment of a finger-identifying keyboard of the invention—both-hand keyboard layout example.

FIG. 3 is another embodiment of a finger-identifying keyboard of the invention—single-hand keyboard layout example.

FIG. 4 is a block diagram of the coding synthesizing function of a finger-identifying keyboard of the invention.

FIG. 5 is an embodiment of the particular electrical circuit of the coding synthesizing of the invention.

Below there will be a detailed description with reference to the accompanying drawings.

### DETAILED DESCRIPTION OF THE INVENTION

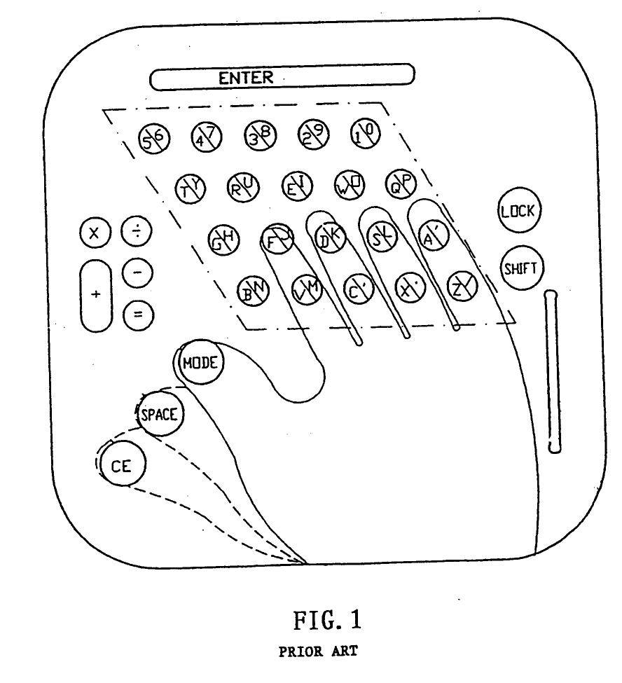

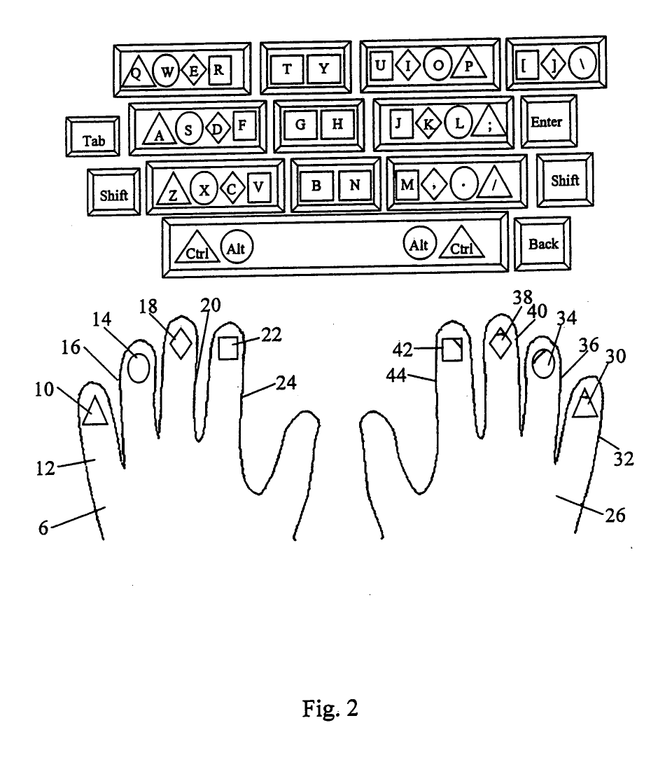

FIG. 1 is a schematic view of a prior art keyboard with reduced size, which has been previously mentioned. FIG. 2 is an embodiment of a finger-identifying keyboard of the invention, in which the layout of a both-hand keyboard is shown. In this FIG. 2, different shapes represent different characters actually produced by the keystroke of different fingers. As shown in the Figure, the whole inputting device comprises a keyboard and a plurality of finger contacts or touching points. The function of the keyboard is the same as that of a conventional keyboard, while the finger contacts are used to distinguish the fingers that press the keys. Here, only four fingers on each hand have the contacts, as conventionally the thumbs are only used for pressing the “space” key. Thus, final coding can be produced directly for the space key. The left hand 6 contains sensors on the fingers designated by the geometric shapes of a triangle 10 on the little finger 12, a circle 14 on the ring finger 16, a diamond 18 on the middle finger 20, and a square 22 on the index finger 24. In like manner, the right hand 26 contains sensors on the fingers, comprising a triangle 30 on the little finger 32, a circle 34 on the ring finger 36, a diamond 38 on the middle finger 40, and a square 42 on the index finger 44. As can be seen in the drawing, the geometric shapes of the sensors on the right hand are truncated to differentiate them from the sensors on the left hand. The implementation of the keyboard connection is the same as that of an ordinary keyboard, with the finger wearing the contacts for connection to the keyboard, and the coding synthesizing components placed inside the keyboard. During a keystroke, the signals from the keyboard and the finger-contacts are simultaneously sent into the coding synthesizing component. After the synthesizing operation, the actual coding is outputted. Hence, the keyboard input interface may employ a standard keyboard interface.

The various fingers can be distinguished for identification in any number of ways, such as shape or color recognition, fingerprint markers, magnetic coding, photoelectric sensors, luminescence sensors, and inductive and capacitive sensors. All of these employ technology that is readily available and that is known to those skilled in the art. Each finger can wear a sensor, which is like a switch that is triggered when a finger contacts a key. Triggering the switch generates a signal or pulse which is sent to the coding synthesizer. The sensor can be made as a ring or a cap that is placed on the tip of the finger. Each finger wears a different sensor, each of which is wired to a different ‘AND’ gate circuit whereby different switches represent different fingers. For magnetic sensors, a magnetic material is added to the key cap to trigger magnetic switches on the fingers.

Among the suppliers of photoelectric, luminescent, inductive, capacitive and magnetic sensors is EMX Industries, Inc. in Cleveland, Ohio. Information concerning this and other suppliers of such products is available at:

### www.globalspec.com

Another approach recognizes that each finger has its own unique fingerprint which can be distinguished by a fingerprint recognition device, such as the type that utilizes ultrasonic technology. Obviously, this requires the input of fingerprints of the user or users into a program before use of the keyboard. This approach eliminates the need for the user to wear anything on the fingers. For more information about fingerprint recognition, numerous sites are found on the Internet at:

### http://directory.google.com/Top/Computers/Security/Biometrics/Software/Fingerprint Recognition/?tc=l.

When wearing a wired sensor (switch), the signal is an electronic pulse that is triggered by the switch or, in the case of fingerprint recognition, the signal can be generated by the device after it recognizes which finger pressed a key.

For more information on contact and proximity (magnetic) switches, the following links are available:
www.seco-larm.com/Magnet.htm
www.smarthome.com/7113.html
www.aaroncake.net/circuits/touch.htm
www.futurlec.com/TouchSwitch.shtml

One signal is generated by the key stroke and the second one is generated by the finger recognition. The signals may be of the same type or they may be different. For example, a key stroke signal could be visual, mechanical or electromechanical, while the finger recognition signal could be electromagnetic or visually generated by the finger used to make the key stroke. The synthesizer then combines these signals, and outputs a third signal which characterizes the symbol being typed.

Employing a finger-identifying keyboard reduces the number of the keys, thus requiring the change of the keyboard layout. For the both-hand keyboard, the keyboard layout can be the same as a conventional one, with the number of keys reduced, thereby reducing the area of the keyboard. For a foldable keyboard, it is easier to fold due to the small number of keys used. The users can readily accept and get used to it by using the conventional keyboard layout. As one key stands for more than one character, it is possible to increase the size or the length of a key appropriately. Here, the space key, CTRL key and ALT key are combined into one. Usually, a thumb is used to press the space key. When the space key is pressed without a contact, a space character is sent out. When the contact of the ring finger is activated at the same time, it means an ALT key. Similarly, when the contact of the little finger is activated at the same time, it means a CRTL key.

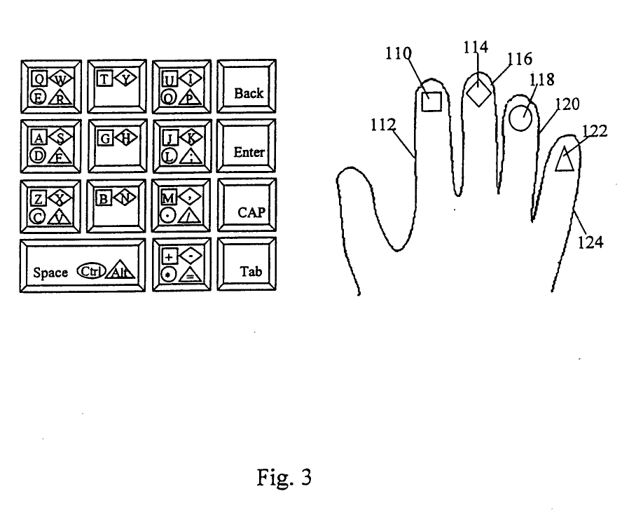

FIG. 3 is an example of the layout of a finger-identifying keyboard of another embodiment of the invention. This is a single-hand keyboard 102. In the Figure, different shapes represent different characters actually produced through keystroke by different fingers. Each key represents four letters and the space key represents “CTRL” and “Alt” keys. Four sensors 110, 114, 118, 122 worn on the fingers 112, 116, 120, 124 are used to distinguish the fingers. In such a way, each key is able to produce four kinds of combinations. Hence, only ten keys can produce 40 combinations, thereby easily implementing all the character inputting functions. Here, there is no need to use additional sensors for the thumbs, since it is only necessary to distinguish different fingers. Therefore, in the design, each key may have its default meaning to be flexibly used in actual applications. For example, the digit keys can be added. The number of keys in the Figure is 15, which can be increased or decreased as needed. For the single-hand keyboard, it is still based on the conventional keyboard. Changing the key positions will make it difficult for the users to remember. The use of the fingers conforms to the convention as much as possible, thereby letting the users quickly get used to such a configuration. Such a miniaturized keyboard layout can reduce the size of the keyboard to that of a PDA so that it can be used for the small handheld devices. In actual application, it may be the case that the left hand is used to hold the keyboard while the right hand is used to operate the keyboard. When only one hand is used for operation, it is difficult to use the SHIFT key, so here CAPS LOCK key is used. Subsidiary functions are used for the combined key functions, i.e. by successively pressing the corresponding keys to implement the combined key functions.

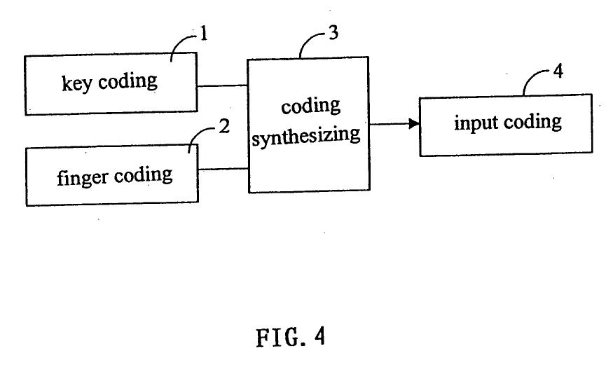

FIG. 4 is a block diagram of the coding synthesizing components of a finger-identifying keyboard of the invention. It generates input code by using coding synthesizing components to synthesize the key coding and the finger coding. The actual input operation consists of two parts; during a keystroke, the pressed key and the contact of the pressing finger produce their coding, respectively, i.e. key coding 1 and finger coding 2. These two parts of coding are coding-synthesized 3 to form actual input coding 4. In actual application, the time of a keystroke may be slightly different from the time when the contact of the finger is activated, thus requiring the coding synthesizing components being able to tolerate some time delay. However, the recovery time after the activation of the keystroke and keyboard should be shorter than this time delay. With respect to the speed of keystrokes by human beings, the operating speed of electric components is far higher than that of human beings; hence, this requirement can be easily met.

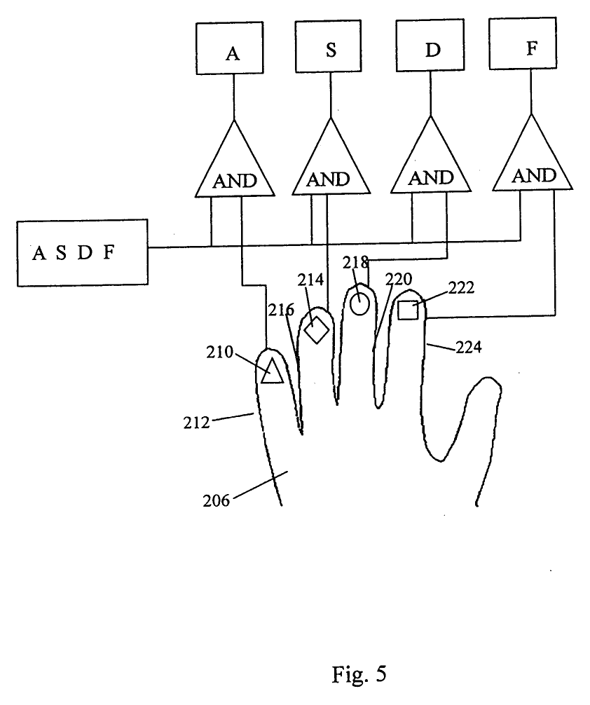

FIG. 5 is an embodiment of the particular electric circuit of the coding synthesizing of the invention. The coding synthesizing circuit can be implemented by using gate circuits, i.e. coding separation can be implemented by the “AND” operation of the keystroke and the sensor contact activation. The left hand 206 contains sensors on the fingers with a triangle 210 on the little finger 212, a circle 214 on the ring finger 216, a diamond 218 on the middle finger 220, and a square 222 on the index finger 224. As shown in the Figure, the characters ASDF that are on the same key can be distinguished by identifying the fingers used. If the little finger 212 is used to press the key, the contact of the 210 sensor of the little finger will be activated, and the result of “AND” operation is a character A. Similarly, the keystroke of the middle finger 220 will result in a character D. Here, the fundamental principle of identification has been explained. The actual coding synthesizing and identification function can be realized by employing conventional electric circuits. Gates of the type that are useful in the implementation of the present invention are available from sources such as Fairchild Semiconductor Corp., Micrel Semiconductor, and Texas Instruments, among others. These AND gates are typically packaged and sold as a single unit as an AND/OR/NOT gate.

The implementation of the keyboard of the invention is basically identical to that of the conventional keyboard, with the contacts of the sensors worn on the fingers for connection to the keyboard. The contacts may be connected wirelessly, e.g. some magnetic materials may be used, as long as the fingers used to press the keys can be distinguished. The keyboard and the sensor contacts can use well-known prior art; the contacts can be implemented by using electricity conducting glue or thin-film switches. To make the finger feel comfortable, the pressure of the contacts should be as weak as possible, i.e. the contacts should be activated once a pressure is sensed such that the fingers will not have unpleasant feeling.

While the present invention has been described with reference to the details of the embodiments of the invention shown in the drawings, these details are not intended to limit the scope of the invention as claimed in the appended claims.

1. A finger-identifying keyboard, comprising:
a plurality of keys;
a plurality of sensors, each of which is uniquely associated with a different finger;
a coding synthesizer used to simultaneously identify the keys and the fingers used to press the keys, to synthesize the coding, and generate the resultant input coding signal.

2. A finger-identifying keyboard according to claim 1, wherein said sensor is a contact sensor.

3. A finger-identifying keyboard according to claim 1, wherein said sensor is a magnetic sensor.

4. A finger-identifying keyboard according to claim 1, wherein the number of said keys is 15.

5. A finger-identifying keyboard according to claim 1, wherein the number of the sensors worn on the fingers is four.

6. A finger-identifying keyboard according to claim 1, wherein the coding synthesizer is an ‘AND’ gate.

7. A keyboard including:
a plurality of keys wherein at least one key of said plurality of keys represents a plurality of different symbols with each symbol representing a different character; and
a synthesizer responsive to a first signal from the at least one key and a second signal from one of the symbols to generate a third signal representative of a particular character.

8. The keyboard of claim 7 wherein the first signal is generated by a finger pressing said at least one key.

9. The keyboard of claim 8 wherein the second signal is provided by a sensor carried on the finger and simultaneously activated with the first signal when the at least one key is pressed.

10. The keyboard of claim 7 wherein the synthesizer includes at least one ‘AND’ gate receiving the first signal and second signal and outputting the third signal.

11. A method to generate key strokes comprising the acts of:
providing a keyboard having a plurality of keys with at least one key representing a plurality of characters;
receiving in a synthesizer a first signal representing activation of said at least one key and a second signal representing activation of one of the plurality of characters; and
generating from said synthesizer a third signal representing a predetermined key stroke.

12. The method of claim 11 wherein the second signal is generated from activation of a sensor carried on a finger.

13. The method of claim 11 wherein the third signal produces a character output.

14. The method according to claim 12 wherein the second signal is generated by a contact sensor on a finger.

15. The method according to claim 12 wherein the second signal is generated by a magnetic sensor on the finger.

16. The method according to claim 12 wherein the keyboard is provided with 15 keys.

17. The method according to claim 12 wherein four finger sensors are placed on only one hand.

18. The method according to claim 12 wherein four finger sensors are placed on each hand.
